(19) United States
(12) Patent Application Publication
(10) Pub. No.: US 2025/0138690 A1
(43) Pub. Date: May 1, 2025

(54) POSITION DETECTION DEVICE AND POSITION DETECTION SYSTEM

(71) Applicant: Wacom Co., Ltd., Saitama (JP)

(72) Inventor: Koji NOGUCHI, Saitama (JP)

(21) Appl. No.: 19/011,287

(22) Filed: Jan. 6, 2025

Related U.S. Application Data
(63) Continuation of application No. PCT/JP2023/022981, filed on Jun. 21, 2023.

(30) Foreign Application Priority Data
Jul. 22, 2022 (JP) 2022-116824

(51) Int. Cl. G06F 3/046; G01D 5/22; G06F 3/0354; G06F 3/041

(52) U.S. Cl. CPC G06F 3/046; G01D 5/2275; G06F 3/03545; G06F 3/0416

(57) ABSTRACT

The disclosure makes it possible to detect a position of an electromagnetic induction pen in a shorter time than in the past. A position detection device includes a plurality of loop coils arranged side by side in an x-direction, and a sensor controller that detects an amplitude of an alternating current signal generated in each of the plurality of loop coils, while supplying an alternating current signal to each of the plurality of loop coils, and detects a position of an electromagnetic induction pen in the x-direction based on the amplitude of the alternating current signal detected in each of the plurality of loop coils.

### BACKGROUND

### Technical Field

The present disclosure relates to a position detection device and a position detection system.

### Description of the Related Art

A position detection device that detects a position of an electromagnetic induction pen by an electromagnetic induction method (EMR method) is known. Patent Document 1 discloses an example of this type of position detection device. The position detection device described in the document has a plurality of X-side loop coils arranged in parallel along an X-axis and a plurality of Y-side loop coils arranged in parallel along a Y-axis, and is configured to drive the X-side loop coils one by one in sequence (by passing a predetermined drive current) while detecting an induced current emerging in each Y-side loop coil. Further, the electromagnetic induction pen described in the literature includes a resonant circuit having a coil and a capacitor.

When a position detection device drives a certain X-side loop coil, a significant induced current is detected in a Y-side loop coil whose intersection with the X-side loop coil is located near the electromagnetic induction pen. The position detection device described in Patent Document 1 is configured to derive coordinates of the electromagnetic induction pen by utilizing properties of such an induced current.

### PRIOR ART DOCUMENT

### Patent Document

Patent Document 1: Japanese Patent Publication No. Hei 05-019164

### BRIEF SUMMARY

### Technical Problem

However, according to the technique of Patent Document 1, since it is necessary to drive the X-side loop coils one by one in sequence, it takes a long time to detect the position. Therefore, there is a need for a technique that can detect the position of the electromagnetic induction pen in a shorter time.

Accordingly embodiments of the present disclosure provide a position detection device and a position detection system capable of detecting the position of an electromagnetic induction pen in a shorter time than in the past.

### Technical Solution

A position detection device according to the present disclosure includes a plurality of first loop coils arranged in a first direction, and a sensor controller that, in operation, detects an amplitude of a first alternating current signal generated in each of the plurality of first loop coils while supplying a second alternating current signal to each of the plurality of first loop coils, and detects a position of an electromagnetic induction pen in the first direction based on the amplitude detected in each of the plurality of first loop coils.

A position detection system according to the present disclosure includes an electromagnetic induction pen and a position detection device, and the electromagnetic induction pen includes a resonant circuit having a coil and a capacitor, wherein the position detection device includes a plurality of first loop coils arranged in a first direction, and a sensor controller that, in operation, detects an amplitude of a first alternating current signal generated in each of the plurality of first loop coils while supplying a second alternating current signal to each of the plurality of first loop coils, and detects a position of the electromagnetic induction pen in the first direction based on the amplitude detected in each of the plurality of first loop coils.

### Advantageous Effect

According to the present disclosure, the position of the electromagnetic induction pen in a first direction can be detected by simultaneously supplying an alternating current signal to each of a plurality of first loop coils, so that the position of the electromagnetic induction pen can be detected in a shorter time than in the past.

### BRIEF DESCRIPTION OF THE SEVERAL VIEWS OF THE DRAWINGS

FIG. 1 is a diagram illustrating a configuration of a position detection system 1 according to an embodiment of the present disclosure.

FIG. 2 is a diagram explaining a method of position detection by a sensor controller 31.

FIG. 3 is a diagram illustrating an example of an amplitude of a received signal Rx detected in each loop coil LCx.

FIG. 4 is a diagram illustrating the internal circuits of the sensor controller 31 and an electromagnetic induction pen 2.

FIGS. 5A to 5D are each a waveform diagram illustrating a simulation result of each signal related to the electromagnetic induction pen 2 and a loop coil LC located in the vicinity of a coil L of the electromagnetic induction pen 2.

FIGS. 6A to 6D are each a waveform diagram obtained by enlarging FIGS. 5A, 5B, 5C, and 5D in a time direction.

FIG. 7 is a processing flow diagram illustrating processing performed by the sensor controller 31 to derive the position of the electromagnetic induction pen 2 and to acquire data transmitted by the electromagnetic induction pen 2.

### DETAILED DESCRIPTION

Hereinafter, an embodiment of the present disclosure will be described in detail with reference to the accompanying drawings.

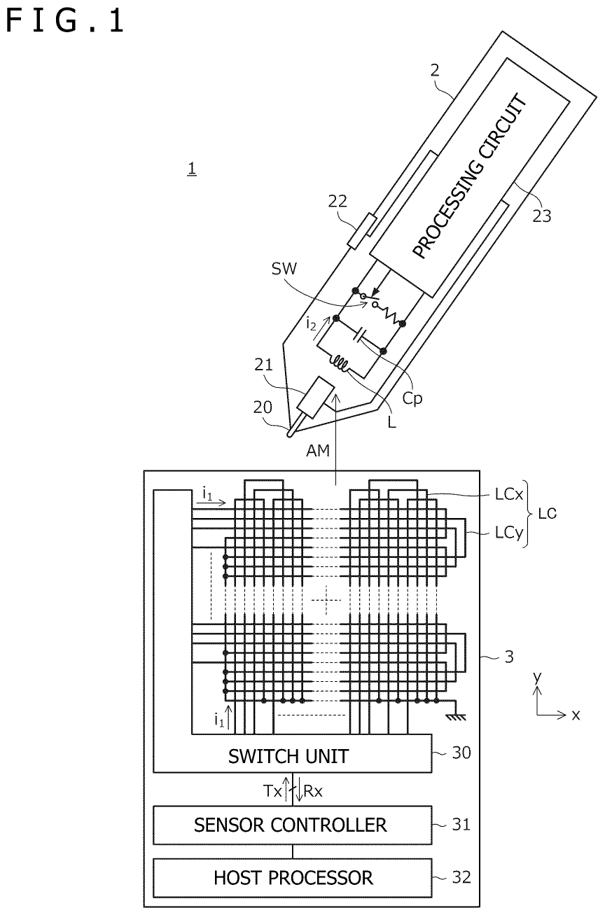

FIG. 1 is a diagram illustrating a configuration of a position detection system 1 according to a first embodiment of the present disclosure. As illustrated in the figure, the position detection system 1 includes an electromagnetic induction pen 2 and a position detection device 3, each of which is compatible with an EMR method. The electromagnetic induction pen 2 among these is a pen-shaped device including a core body 20, a pressure sensor 21, a side switch 22, a processing circuit 23, a coil L, a capacitor Cp, and a switch element SW. The coil L and the capacitor Cp are connected in series, and the switch element SW is connected in parallel to the capacitor Cp.

Meanwhile, the position detection device 3 is a device including a plurality of loop coils LC, a switch unit 30, a sensor controller 31, and a host processor 32. The plurality of loop coils LC include a plurality of loop coils LCx (first loop coils) arranged in an x direction (first direction) and a plurality of loop coils LCy (second loop coils) arranged in a y direction (second direction) perpendicular to the x direction. A typical example of the position detection device 3 is a tablet terminal or a notebook computer whose display surface also serves as a touch surface, but the position detection device 3 may be configured by a digitizer or the like that does not have a display surface.

Before the configuration of the electromagnetic induction pen 2 and the position detection device 3 is described in detail, an outline of the present disclosure will be described. When the sensor controller 31 supplies an alternating current signal Tx (second alternating current signal) to each of the plurality of loop coils LCx, an alternating current signal i₁ (first alternating current signal) flows through each loop coil LCx, and an alternating magnetic field AM is sent out from the touch surface. When the switch element SW is off and the coil L enters this alternating magnetic field AM, an electromotive force is generated in the coil L, and an alternating current signal (third alternating current signal) flows in the resonant circuit formed by the coil L and the capacitor Cp. When this alternating current signal is referred to as i₂, a relation indicated in the following expression (1) is established between the alternating current signal Tx and the alternating current signals i₁ and i₂. Here, Li is the self-inductance of the loop coil LCx, and M is the mutual inductance between the loop coil LCx and the coil L.

$$Math . 1$$

$$Tx = {L}_{1} \frac{{di}_{1}}{dt} + M \frac{{di}_{2}}{dt} \qquad ( 1 )$$

The alternating current signal Tx is a signal having a constant amplitude. Therefore, it is understood from the expression (1) that when the alternating current signal i₂ is generated, the amplitude of the alternating current signal i₁ is reduced accordingly. In addition, considering that as a distance between the loop coil LCx and the coil L becomes shorter, the mutual inductance M becomes greater, it is understood from the expression (1) that as the distance between the loop coil LCx and the coil L becomes shorter, the reduction in the amplitude of the alternating current signal i₁ becomes greater. In other words, it is understood that the amplitude of the alternating current signal i₁ detected in the loop coil LCx that is relatively close to the coil L is smaller than the amplitude of the alternating current signal i₁ detected in the loop coil LCx that is relatively far from the coil L. These mean that the position of the coil L in the x direction can be determined from the reduction in the amplitude of the alternating current signal i₁.

Therefore, in the present embodiment, the sensor controller 31 is configured to detect the amplitude of the alternating current signal i₁ generated in each loop coil LCx when supplying the alternating current signal Tx to each loop coil LCx, and detect the position of the electromagnetic induction pen 2 in the x direction on the basis of the detected amplitude. The same method applies to the y direction, and in the present embodiment, the sensor controller 31 is configured to detect the amplitude of the alternating current signal i₁ generated in each loop coil LCy when supplying the alternating current signal Tx to each loop coil LCy, and detect the position of the electromagnetic induction pen 2 in the y direction on the basis of the detected amplitude. According to the sensor controller 31 configured in this manner, since the position of the electromagnetic induction pen 2 in the x direction (or y direction) can be detected by simultaneously supplying the alternating current signal Tx to each of the plurality of loop coils LCx (or the plurality of loop coils LCy), it is possible to detect the position of the electromagnetic induction pen 2 in a shorter time than a conventional sensor controller that drives the loop coils LCx one by one in sequence while detecting the induced current emerging in each loop coil LCy.

In the present embodiment, the above principle is also used to transmit data from the electromagnetic induction pen 2 to the sensor controller 31. That is, when the switch element SW is on, the capacitor Cp is short-circuited, and therefore the above-mentioned resonant circuit is not formed in the electromagnetic induction pen 2. Then, the alternating current signal i₂ is not generated, and as a result, the amplitude of the alternating current signal i₁ does not decrease. This means that by turning on and off the switch element SW, it is possible to switch between a state in which the amplitude of the alternating current signal i₁ decreases and a state in which the amplitude does not decrease in the loop coil LCx close to the coil L.

Therefore, in the present embodiment, the electromagnetic induction pen 2 is configured to turn on and off the switch element SW according to the contents of the data to be transmitted, and the sensor controller 31 is configured to acquire the data transmitted by the electromagnetic induction pen 2 by demodulating the alternating current signal i₁ in each loop coil LCx on the basis of its amplitude. With these configurations, it becomes possible to transmit data from the electromagnetic induction pen 2 to the sensor controller 31 in parallel with the detection of the position of the electromagnetic induction pen 2 by the sensor controller 31.

Each of the configurations of the electromagnetic induction pen 2 and the position detection device 3 for achieving the above-mentioned position detection and data transmission will be described in detail below. First, focusing on the electromagnetic induction pen 2, the core body 20 is a rod-shaped member that constitutes the pen tip of the electromagnetic induction pen 2 and is configured to be movable in the pen axis direction. A rear end of the core body 20 is in contact with a pressure sensor 21. The pressure sensor 21 is a sensor that detects the pressure applied to the pen tip by detecting the pressing force from the rear end of the core body 20, and is configured to supply a value indicating the detected pressure (writing pressure value) to the processing circuit 23.

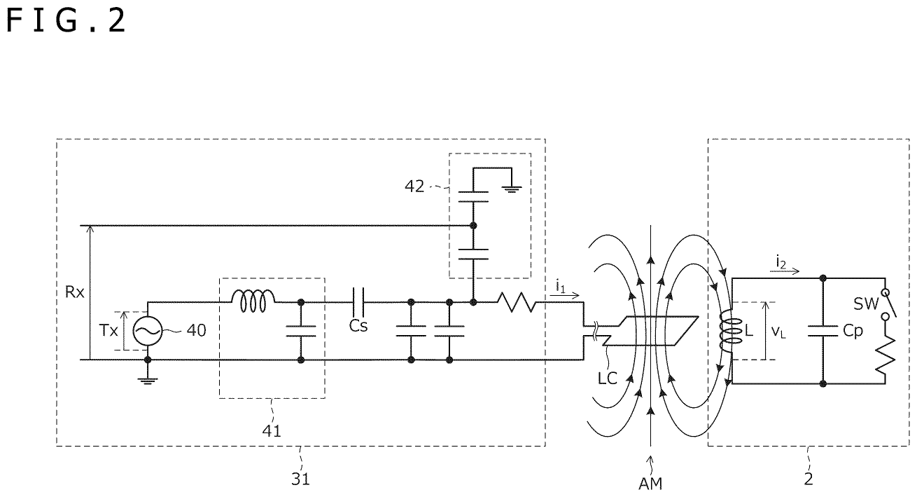

The side switch 22 is an on-off type switch provided on a surface of the electromagnetic induction pen 2, and is configured to supply information indicating its own on-off state (on-off information) to the processing circuit 23. Note that, although an example in which the electromagnetic induction pen 2 has one side switch 22 is illustrated in FIG. 2, the electromagnetic induction pen 2 may have a plurality of side switches 22. Also, a similar switch may be provided on a surface of the electromagnetic induction pen 2 other than the side surface thereof (for example, an end portion).

The coil L is an inductor that is provided near the pen tip and is subjected to magnetic field coupling with a loop coil LC in the position detection device 3. The coil L is connected in series with the capacitor Cp and forms a resonant circuit together with the capacitor Cp. The inductance of the coil L and the capacitance of the capacitor Cp are such that the resonant frequency of this resonant circuit is substantially equal to the frequency of the alternating current signal Tx. When the coil L enters the alternating magnetic field AM emitted by the position detection device 3, an electromotive force is excited in the coil L by electromagnetic induction, the alternating current signal i₂ is generated in the resonant circuit, and thus power is stored in the capacitor Cp.

The switch element SW is a single-pole-single-throw switch connected in series to the capacitor Cp. The coil L and the capacitor Cp function as a resonant circuit when the switch element SW is off, but do not function as a resonant circuit when the switch element SW is on because the capacitor Cp is short-circuited. When the coil L and the capacitor Cp do not function as a resonant circuit, the above-mentioned alternating current signal i₂ is not generated even when the coil L is in the alternating magnetic field AM.

The processing circuit 23 is an integrated circuit that executes on-off control of the switch element SW on the basis of data to be transmitted to the position detection device 3, and thereby transmits data to the position detection device 3. Examples of the data to be transmitted include a pen identification (ID) uniquely assigned to the electromagnetic induction pen 2 as well as the above-mentioned writing pressure value and on-off information.

The processing circuit 23 keeps the switch element SW off in the initial state and performs an operation of detecting the alternating current signal i₂ generated in the resonant circuit by the alternating magnetic field AM sent out by the position detection device 3. Further, the processing circuit 23 is configured to execute, when detecting the generation of the alternating current signal i₂, on-off control of the switch element SW for transmitting data for a predetermined time from the timing of generation of the alternating current signal i₂ (i.e., the timing when the sensor controller 31 starts supplying the alternating current signal Tx to the loop coil LC).

In one example, the processing circuit 23 controls to turn on the switch element SW when transmitting data “0” and controls to turn off the switch element SW when transmitting data “1.” This is none other than on-off modulation of the alternating current signal i₂ by on-off control of the switch element SW. The position detection device 3 receives the data transmitted by the processing circuit 23 by detecting this on-off modulation as the presence or absence of a decrease in the amplitude of the alternating current signal i₁.

Next, focusing on the position detection device 3, the plurality of loop coils LC are coils arranged in the touch surface, and include the plurality of loop coils LCx and LCy described above. One end of each loop coil LC is connected to the switch unit 30, and the other end is grounded. The switch unit 30 is a circuit that plays a role in connecting one or more of the plurality of loop coils LC to the sensor controller 31 in response to the control of the sensor controller 31.

The sensor controller 31 is an integrated circuit having a function of detecting the position of the electromagnetic induction pen 2 on the touch surface, and acquiring data transmitted by the electromagnetic induction pen 2, and thereby sequentially supplying the detected position and acquired data to the host processor 32. In order to perform these processes, the sensor controller 31 simultaneously supplies alternating current signals Tx to the plurality of loop coils LCx, and performs a process of detecting the amplitude of the alternating current signal i₁ generated in each loop coil LCx at that time. Further, the sensor controller 31 simultaneously supplies the alternating current signals Tx to the plurality of loop coils LCy, and performs a process of detecting the amplitude of the alternating current signal i₁ generated in each loop coil LC at that time.

FIG. 2 is a diagram illustrating the internal circuit of the sensor controller 31. The diagram also illustrates one of the plurality of loop coils LC provided in the position detection device 3 and also a circuit in the electromagnetic induction pen 2 (the same as that illustrated in FIG. 1). The sensor controller 31 is configured to have the circuit illustrated in the figure for each loop coil LC.

As illustrated in FIG. 2, the sensor controller 31 includes a signal source 40 that generates the alternating current signal Tx that oscillates at a constant frequency and amplitude, a high-pass filter 41, a capacitor Cs that forms a resonant circuit together with the loop coil LC, and a voltage-dividing circuit 42. The alternating current signal Tx generated by the signal source 40 is supplied to a resonant circuit formed by the loop coil LC and the capacitor Cs after low-frequency noise is removed by the high-pass filter 41. Then, the alternating current signal i₁ illustrated in the figure is generated in the resonant circuit, and as a result, the alternating magnetic field AM as illustrated is generated. When the coil L enters this alternating magnetic field AM, and when the switch element SW is off, the alternating current signal i₂ is generated in the resonant circuit formed by the coil L and the capacitor Cp, whereas when the switch element SW is on, no alternating current signal i₂ is generated.

The voltage-dividing circuit 42 is connected between the resonant circuit formed by the loop coil LC and the capacitor Cs, and the ground terminal, and the amplitude of the alternating current signal i₁ is reflected in the output signal thereof. The sensor controller 31 detects the output signal of the voltage-dividing circuit 42, which reflects the amplitude of the alternating current signal i₁, as the received signal Rx. Incidentally, the voltage-dividing circuit 42 is used to adjust the amplitude of the received signal Rx according to the dynamic range of an unillustrated subsequent circuit.

As can be understood from the above expression (1), when the coil L of the electromagnetic induction pen 2 is present near the loop coil LC, and the alternating current signal i₂ flows therethrough, the amplitude of the alternating current signal i₁ is smaller than the amplitude when the coil L of the electromagnetic induction pen 2 is not present near the loop coil LC or when the coil L is present but the alternating current signal i₂ does not flow therethrough. The sensor controller 31 is configured to detect the amplitude of the alternating current signal i₁ by detecting the amplitude of the received signal Rx in a subsequent circuit (not illustrated), and to detect the position of the electromagnetic induction pen 2 on the basis of the result, and further to demodulate the data transmitted by the electromagnetic induction pen 2.

Here, in the conventional position detection device 3, the frequency of the alternating current signal Tx is often set to 666 kHz, but in the present embodiment, it is preferable to set the frequency of the alternating current signal Tx to a value higher than 666 kHz. In a typical example, the frequency of the alternating current signal Tx is set to 13.56 MHz. The reason for setting the frequency of the alternating current signal Tx to a high value in this manner is that as the frequency of the alternating current signal Tx becomes higher, the change in amplitude of the alternating current signal i₁ due to the presence or absence of the alternating current signal i₂ becomes larger, and the detection accuracy of the amplitude change in the sensor controller 31 becomes higher.

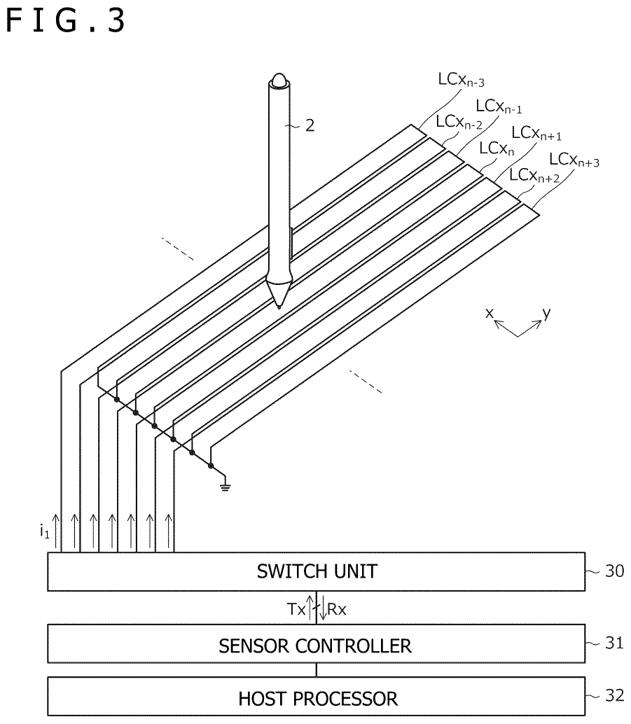

FIG. 3 is a diagram for describing a method for detecting the position of the electromagnetic induction pen 2 by detecting the amplitude of the received signal Rx. This figure illustrates a case where the position of the electromagnetic induction pen 2 in the x direction is detected. Further, this figure illustrates a case where the coil L of the electromagnetic induction pen 2 is located above the loop coil LCxₙ, among the plurality of loop coils LCx including the illustrated seven loop coils LCxₙ₋₃ to LCxₙ₊₃. The sensor controller 31 first supplies the alternating current signal Tx to each loop coil LCx, and at the same time, detects the received signal Rx in each loop coil LCxₙ.

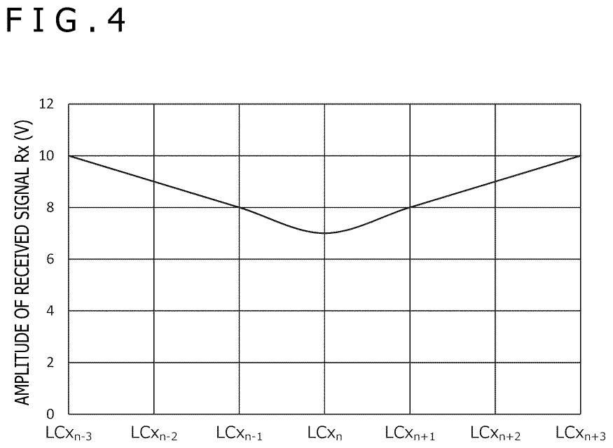

FIG. 4 is a diagram illustrating the amplitude of the received signal Rx detected in each loop coil LCx illustrated in FIG. 3. As illustrated in the figure, the amplitude of the received signal Rx is smallest in the loop coil LCxₙ closest to the coil L, and decreases with increasing distance from the loop coil LCxₙ. When detecting the amplitude of the received signal Rx in each loop coil LCx, the sensor controller 31 approximates the value by using a predetermined approximation curve and derives the position in the x direction corresponding to the vertex. Then, the sensor controller 31 detects the derived position as the position of the electromagnetic induction pen 2 in the x direction. The position in the y direction is also similarly detected.

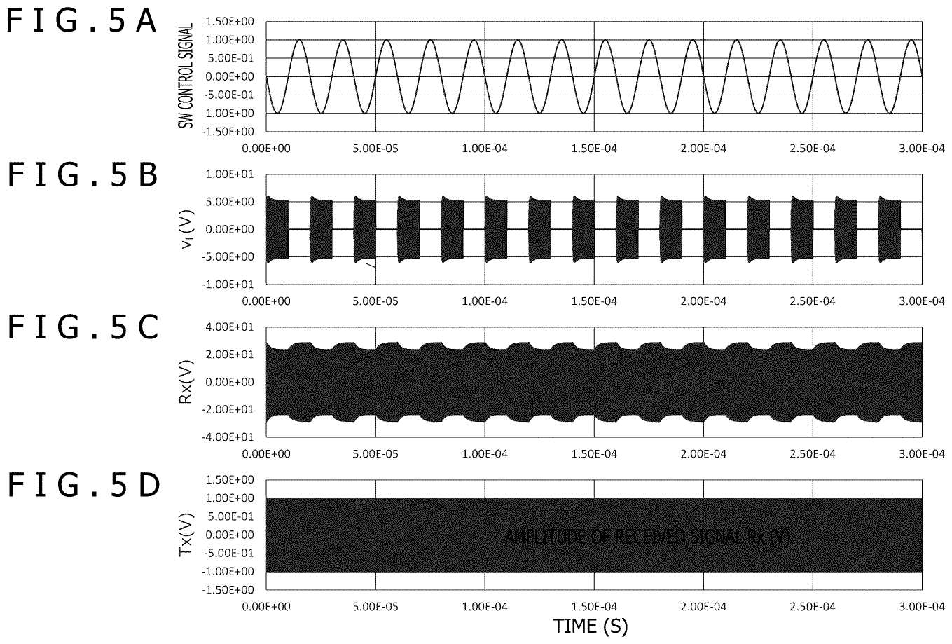

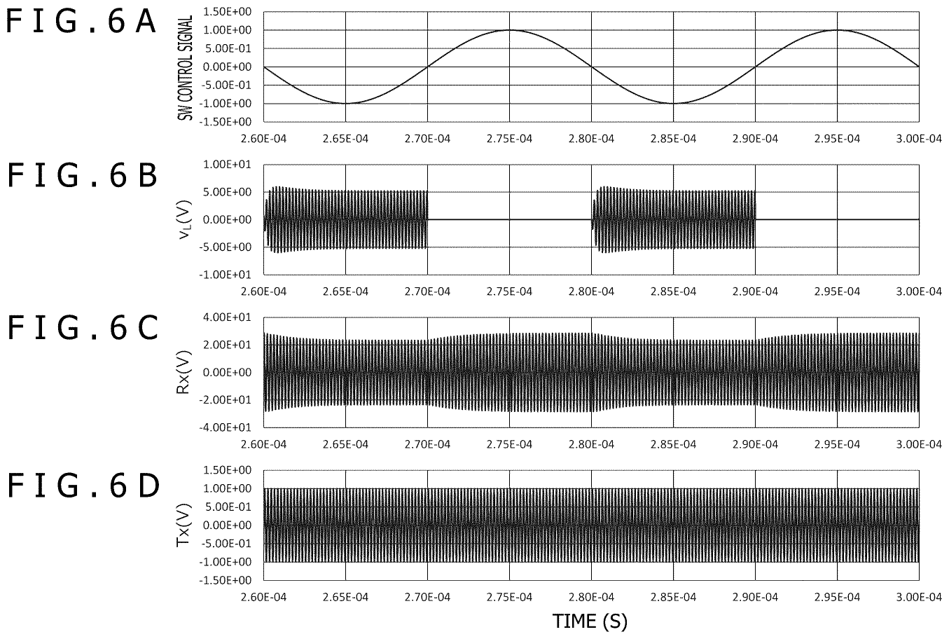

Each of FIGS. 5A, 5B, 5C, and 5D is a waveform diagram illustrating a simulation result of each signal related to the electromagnetic induction pen 2 and the loop coil LC located in the vicinity of the coil L of the electromagnetic induction pen 2. The figures illustrate the waveform of each signal when the switch element SW of the electromagnetic induction pen 2 is turned on and off at a constant cycle. Each of FIGS. 6A, 6B, 6C, and 6D is a waveform diagram obtained by enlarging FIGS. 5A, 5B, 5C, and 5D, respectively, in a time direction.

FIG. 5A illustrates the simulation result of the SW control signal generated in the processing circuit 23 to control the switch element SW. The processing circuit 23 is configured to turn on the switch element SW when the value of the SW control signal changes from a value less than 0 to a value greater than 0, and to turn off the switch element SW when the value of the SW control signal changes from a value greater than 0 to a value less than 0. FIGS. 5B, 5C, and 5D illustrate a simulation results of the voltage V_{L} (the voltage between both ends of the coil L), the received signal Rx, and the alternating current signal Tx illustrated in FIG. 2, respectively.

As can be seen from FIGS. 5A, 5B, 5C, 5D, 6A, 6B, 6C, and 6D when the switch element SW is off, the voltage V_{L} is generated, which results in the generation of the alternating current signal i₂ illustrated in FIG. 2, whereas when the switch element SW is on, the voltage V_{L} is not generated, and the alternating current signal i₂ illustrated in FIG. 2 does not flow. Then, when the voltage V_{L} is generated, the amplitude of the received signal Rx becomes smaller than that when the voltage V_{L} is not generated. The sensor controller 31 demodulates the received signal Rx that changes in this way, by using a modulation method similar to on-off modulation (for example, a method of assigning “0” when the amplitude is relatively large and assigning “1” when the amplitude is relatively small), to obtain data transmitted by the electromagnetic induction pen 2 using on-off modulation by turning the switch element SW on and off.

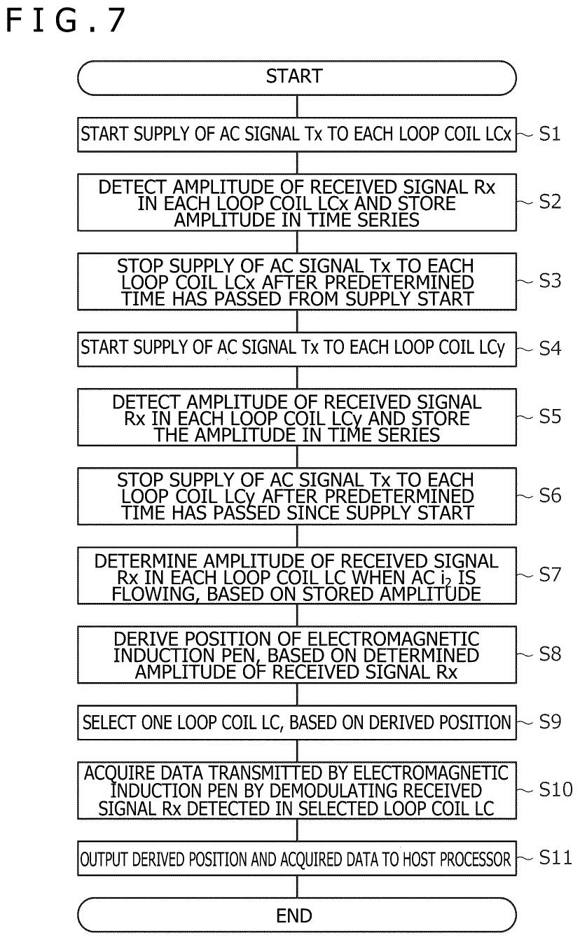

FIG. 7 is a process flow diagram illustrating a process performed by the sensor controller 31 to derive the position of the electromagnetic induction pen 2 and to acquire data transmitted by the electromagnetic induction pen 2. The sensor controller 31 is configured to periodically execute the process illustrated in the diagram.

As illustrated in FIG. 7, the sensor controller 31 first starts supplying the alternating current signal Tx to each loop coil LCx (S1), and while supplying the signal, detects the amplitude of the received signal Rx in each loop coil LCx to store the amplitude in time series (S2). To be specific, it is sufficient if the received signal Rx is sampled at a predetermined sampling frequency, and a series of digital values obtained as a result of sampling are stored. After a predetermined time has elapsed from the start of supply at S1, the sensor controller 31 stops supplying the alternating current signal Tx to each loop coil LCx (S3). The sensor controller 31 then performs a similar process also for the loop coil LCy (steps S4 to S6).

Next, the sensor controller 31 determines the amplitude of the received signal Rx in each loop coil LC when the alternating current signal i₂ is flowing, based on the stored series of amplitudes (S7). That is, when the electromagnetic induction pen 2 transmits data by turning on and off the switch element SW, the amplitude of the received signal Rx fluctuates between relatively large and small cases as illustrated in FIG. 5C. In this case, since the period in which the amplitude of the received signal Rx is relatively small corresponds to the period in which the alternating current signal i₂ is flowing, the sensor controller 31 determines the amplitude of this period as the amplitude of the received signal Rx when the alternating current signal i₂ is flowing. When the electromagnetic induction pen 2 is not transmitting data and when the electromagnetic induction pen 2 is not present in the vicinity of the corresponding loop coil LC, the amplitude of the received signal Rx does not fluctuate, but in that case, it is sufficient if the sensor controller 31 determines the stored amplitude (amplitude that is a constant value) as the amplitude of the received signal Rx in each loop coil LC when the alternating current signal i₂ is flowing.

Next, the sensor controller 31 derives the position of the electromagnetic induction pen 2 on the basis of the amplitude of the received signal Rx determined at S7 (S8). To be specific, it is sufficient if the sensor controller 31 approximates the amplitude of the received signal Rx in each loop coil LCx by using a predetermined approximation curve to derive the position corresponding to the vertex of the curve as the position of the electromagnetic induction pen 2 in the x direction, and approximates the amplitude of the received signal Rx in each loop coil LCy by a predetermined approximation curve to derive the position corresponding to the vertex of the curve as the position of the electromagnetic induction pen 2 in the y direction.

Next, the sensor controller 31 selects one loop coil LC on the basis of the position derived at S9 (S9). To be specific, it is sufficient to select the loop coil LCx closest to the position in the x direction derived at S9 (or the loop coil LCy closest to the position in the y direction derived at S9). Then, the sensor controller 31 acquires the data transmitted by the electromagnetic induction pen 2, by demodulating the received signal Rx detected in the selected loop coil LC (a signal represented by a series of amplitudes stored at S2 or S5) (S10). In a specific example, it is sufficient if the sensor controller 31 demodulates the received signal Rx by assigning “0” when the amplitude of the received signal Rx is relatively large and assigning “1” when the amplitude of the received signal Rx is relatively small.

Finally, the sensor controller 31 outputs the position derived at S9 and the data acquired at S9 to the host processor 32, and ends the series of processes (S11). As described above, the sensor controller 31 according to the present embodiment can detect the position of the electromagnetic induction pen 2 without driving the loop coils LCx one by one in sequence, and further, it becomes possible to transmit data from the electromagnetic induction pen 2 to the sensor controller 31 in parallel with the process for detecting the position.

Described with reference to FIG. 1 again, the host processor 32 performs such processes as moving a cursor displayed on the display surface and generating stroke data indicating the trajectory of the electromagnetic induction pen 2 on the touch surface, by using the position and data supplied from the sensor controller 31. With regard to the stroke data among these, the host processor 32 also performs such processes as rendering and displaying the generated stroke data, generating and recording digital ink including the generated stroke data, and transmitting the generated digital ink to an external device in response to a user instruction.

As described above, according to the position detection system 1 of the present embodiment, the position of the electromagnetic induction pen 2 in the x direction can be detected by simultaneously supplying the alternating current signal Tx to each of the plurality of loop coils LCx. The position in the y direction is similarly detected. Therefore, it is possible to detect the position of the electromagnetic induction pen 2 in a shorter time than in the conventional method of driving the loop coils LCx one by one in sequence while detecting the induced current emerging in each loop coil LCy.

In addition, since the electromagnetic induction pen 2 transmits data by using on-off modulation performed by turning on and off of the switch element SW, and the sensor controller 31 demodulates the change in amplitude of the received signal Rx, it becomes possible to transmit data from the electromagnetic induction pen 2 to the sensor controller 31 in parallel with the detection of the position of the electromagnetic induction pen 2 by the sensor controller 31.

Although the preferred embodiment of the present disclosure has been described above, the present disclosure is not limited to the embodiment, and it goes without saying that the present disclosure can be embodied in various forms without departing from the spirit of the present disclosure.

For example, in the above embodiment, the supply of the alternating current signal Tx to each loop coil LCx and the supply of the alternating current signal Tx to each loop coil LCy are carried out in a time-division manner, but these may be performed simultaneously. Also, the detection of the amplitude of the received signal Rx in each loop coil LCx and the detection of the amplitude of the received signal Rx in each loop coil LCy may be performed simultaneously. In this way, it becomes possible to detect the position of the electromagnetic induction pen 2 in an even shorter time than in the above embodiment.

### DESCRIPTION OF REFERENCE SYMBOLS

1: Position detection system
2: Electromagnetic induction pen
3: Position detection device
20: Core body
21: Pressure sensor
22: Side switch
23: Processing circuit
30: Switch unit
31: Sensor controller
32: Host processor
40: Signal source
41: High-pass filter
42: Voltage-dividing circuit
L: Coil
Cp, Cs: Capacitor
LC, LCx, LCy: Loop coil
SW: Switch element

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A position detection device comprising:
a plurality of first loop coils arranged in a first direction; and
a sensor controller that, in operation,
detects an amplitude of a first alternating current signal generated in each of the plurality of first loop coils while a second alternating current signal is supplied to each of the plurality of first loop coils, and
detects a position of an electromagnetic induction pen in the first direction, based on the amplitude detected in each of the plurality of first loop coils.

2. The position detection device according to claim 1, wherein
the amplitude detected in one of the plurality of first loop coils that is relatively close to a coil in the electromagnetic induction pen is smaller than the amplitude detected in one of the plurality of first loop coils that is relatively far from the coil in the electromagnetic induction pen.

3. The position detection device according to claim 1, wherein
the sensor controller has a signal source, and
the second alternating current signal is a signal supplied from the signal source to each of the plurality of first loop coils.

4. The position detection device according to claim 1, further comprising:
a plurality of second loop coils arranged in a second direction perpendicular to the first direction, wherein
the sensor controller, in operation,
detects the amplitude of the first alternating current signal generated in each of the plurality of second loop coils while the second alternating current signal is supplied to each of the plurality of second loop coils, and
detects the position of the electromagnetic induction pen in the second direction, based on the amplitude detected in each of the plurality of second loop coils.

5. The position detection device according to claim 1, wherein
the sensor controller, in operation,
selects one of the plurality of first loop coils, based on the position of the electromagnetic induction pen in the first direction, and
acquires data transmitted by the electromagnetic induction pen, by demodulating the first alternating current signal generated in the one of the first loop coils.

6. The position detection device according to claim 1, wherein
the sensor controller, in operation,
stores the amplitude of the first alternating current signal generated in each of the plurality of first loop coils, in a time series,
determines the amplitude of the first alternating current signal in each of the plurality of first loop coils when a third alternating current signal is generated in a resonant circuit in the electromagnetic induction pen, based on the amplitude of the first alternating current signal in each of the plurality of first loop coils stored in the time series, and
detects the position of the electromagnetic induction pen in the first direction, based on the amplitude of the first alternating current signal in each of the plurality of first loop coils.

7. The position detection device according to claim 1, further comprising:
a voltage-dividing circuit connected to each of the plurality of first loop coils, wherein
the sensor controller, in operation, detects an amplitude of an output signal of the voltage-dividing circuit to detect the amplitude of the first alternating current signal generated in a corresponding one of the first loop coils.

8. A position detection system comprising:
an electromagnetic induction pen; and
a position detection device,
wherein the electromagnetic induction pen includes a resonant circuit having a coil and a capacitor, and
wherein the position detection device includes:
a plurality of first loop coils arranged in a first direction, and
a sensor controller that. in operation,
detects an amplitude of a first alternating current signal generated in each of the plurality of first loop coils while supplying a second alternating current signal to each of the plurality of first loop coils, and
detects a position of the electromagnetic induction pen in the first direction, based on the amplitude detected in each of the plurality of first loop coils.

9. The position detection system according to claim 8, wherein
the resonant circuit has a resonant frequency that is substantially equal to a frequency of the first alternating current signal, and
the amplitude detected in one of the plurality of first loop coils that is relatively close to the coil in the electromagnetic induction pen is smaller than the amplitude detected in one of the plurality of first loop coils that is relatively far from the coil in the electromagnetic induction pen.

10. The position detection system according to claim 8, wherein
the position detection device further includes a plurality of second loop coils arranged in a second direction perpendicular to the first direction, and
the sensor controller, in operation,
detects the amplitude of the first alternating current signal generated in each of the plurality of second loop coils while the second alternating current signal passes through each of the plurality of second loop coils, and
detects a position of the electromagnetic induction pen in the second direction, based on the amplitude detected in each of the plurality of second loop coils.

11. The position detection system according to claim 8, wherein
the electromagnetic induction pen includes:
a switch connected in parallel with the capacitor; and
a processing circuit that, in operation, transmits, based on data to be transmitted to the position detection device, the data to the position detection device by performing on-off control of the switch, and
the sensor controller, in operation,
selects one of the plurality of first loop coils, based on the position of the electromagnetic induction pen in the first direction, and
obtains the data transmitted by the electromagnetic induction pen, by demodulating the first alternating current signal generated in the one of the first loop coils.

12. The position detection system according to claim 11, wherein
the processing circuit, in operation, detects a third alternating current signal generated in the resonant circuit, and performs on-off control of the switch to transmit the data for a predetermined period of time from a timing of generation of the third alternating current signal.

13. The position detection system according to claim 8, wherein
the sensor controller, in operation,
stores the amplitude of the first alternating current signal generated in each of the plurality of first loop coils, in a time series,
determines the amplitude of the first alternating current signal in each of the plurality of first loop coils when a third alternating current signal is generated in the resonant circuit, based on the amplitude of the first alternating current signal in each of the plurality of first loop coils stored in the time series, and
detects the position of the electromagnetic induction pen in the first direction, based on the amplitude of the first alternating current signal in each of the plurality of first loop coils.

14. The position detection system according to claim 8,
wherein the sensor controller includes a voltage-dividing circuit connected to each of the plurality of first loop coils, and
wherein the sensor controller, in operation, detects an amplitude of an output signal of the voltage-dividing circuit to detect the amplitude of the first alternating current signal generated in a corresponding one of the first loop coils.
